(19) United States
(12) Patent Application Publication
(10) Pub. No.: US 2025/0231675 A1
(43) Pub. Date: Jul. 17, 2025

(54) INFORMATION PROCESSING METHOD, INFORMATION PROCESSING APPARATUS, AND STORAGE MEDIUM

(71) Applicant: CANON KABUSHIKI KAISHA, Tokyo (JP)

(72) Inventor: Tomoya ISHIDA, Kanagawa (JP)

(21) Appl. No.: 19/007,631

(22) Filed: Jan. 2, 2025

(30) Foreign Application Priority Data
Jan. 11, 2024 (JP) 2024-002654

(51) Int. Cl. G06F 3/04845; G06F 3/0482; G06F 40/242; G06T 11/60

(52) U.S. Cl. CPC G06F 3/04845; G06F 3/0482; G06F 40/242; G06T 11/60; G06T 2200/24

(57) ABSTRACT

The information processing apparatus for causing a generation AI to generate contents includes a derivation unit configured to derive a specific character string based on information obtained relating to a user and a setting unit configured to set the specific character string derived by the derivation unit as a negative prompt designating the generation AI should not to generate what kind of contents.

### BACKGROUND

### Field

The present disclosure relates to prompt setting of an image generation AI.

### Description of the Related Art

As one of the functions of software creating a posture, a leaflet and the like, there is a function with which a user selects a desired template from among a variety of templates prepared in advance and inserts an arbitrary character, an image captured by the user him/herself, and the like into the template. In this regard, Japanese Patent Laid-Open No. 2017-037557 has disclosed a technique to enable retrieval of an image suitable to a template from an image group prepared separately by extracting a word from property information on an object, which is included in the template, and creating a retrieval keyword.

For example, among software creating a poster and the like, software having a function of generating an image by using a generation AI (Artificial Intelligence) has appeared. This image generation function is a function with which in a case were a user inputs a word or sentence as a prompt to the generation AI, the AI automatically generates an image based on the input prompt (word or sentence). Here, for example, it is assumed that the template of a poster to be used is in the style of illustration. In a case of inserting an image into the template in the style of illustration, a user inputs an arbitrary prompt to the generation AI in expectation of an image in the same style of illustration. However, in a case where a prompt the user inputs is not appropriate, the generation AI generates, for example, a realistic image, and therefore, it may happen that the image is not suitable to the style and atmosphere of the template to be used. In the case such as this, it is necessary for the user to repeat image generation by the generation AI by making an attempt to input another prompt and so on, and therefore, it takes time and effort of the user. As described above, to find out and input an appropriate prompt for obtaining desired contents to the generation AI is a difficult and time-consuming work for a user.

### SUMMARY

The information processing apparatus for causing a generation AI to generate contents according to the present disclosure includes: one or more memories storing instructions; and one or more processors executing the instructions for: deriving a specific character string based on information obtained relating to a user; and setting the derived specific character string as a negative prompt designating the generation AI should not to generate what kind of contents.

Further features of the present disclosure will become apparent from the following description of exemplary embodiments with reference to the attached drawings.

### BRIEF DESCRIPTION OF THE DRAWINGS

FIG. 1 is a diagram showing a configuration example of a client-server system according to the present embodiment;

FIG. 2 is a diagram showing one example of a hardware configuration of an information processing apparatus;

FIG. 3 is a function block diagram showing one example of a software configuration of a frontend application and a backend application;

FIG. 4 is a diagram showing examples of negative prompts;

FIG. 5 is a flowchart showing a flow of operations in a client;

FIG. 6A and FIG. 6B are each a diagram showing one example of a poster editing screen;

FIG. 7A and FIG. 7B are each a diagram showing one example of the poster editing screen;

FIG. 8A and FIG. 8B are each a diagram showing one example of the poster editing screen;

FIG. 9 is a flowchart showing a flow of operations in a server;

FIG. 10A and FIG. 10B are each a diagram showing one example of the poster editing screen;

FIG. 11A is a diagram explaining the way a character string of a negative prompt is derived and FIG. 11B is a diagram showing one example of a UI screen on which to set a negative prompt from a derived character string group;

FIG. 12A to FIG. 12C are each a diagram explaining the way an impression of an image is obtained by using a learned model; and

FIG. 13A and FIG. 13B are each a diagram explaining automatic updating of a negative prompt.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

### First Embodiment

### System Configuration

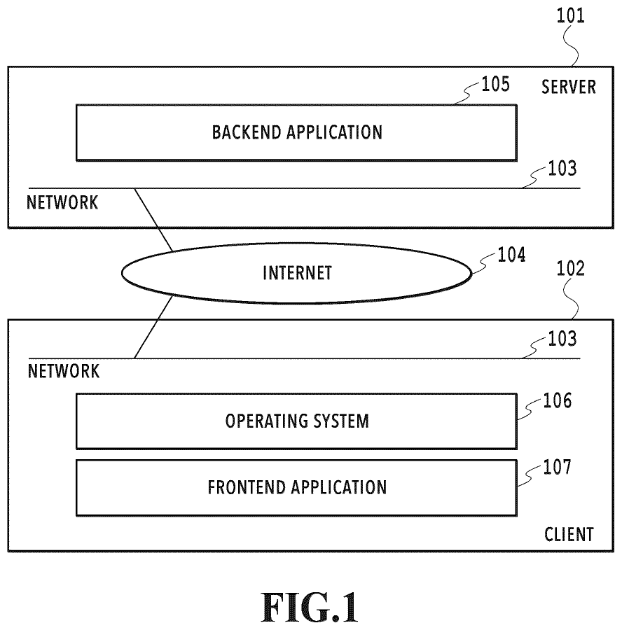

FIG. 1 is a diagram showing a configuration example of a client-server system according to the present embodiment. This system includes a server 101 that provides contents generation services and a client 102 that utilizes the services. The server 101 and the client 102 communicate with each other via an internet 104 from each network 103. The server 101 has a backend application 105. The client 102 has an operating system 106 and a frontend application 107.

### Hardware Configuration

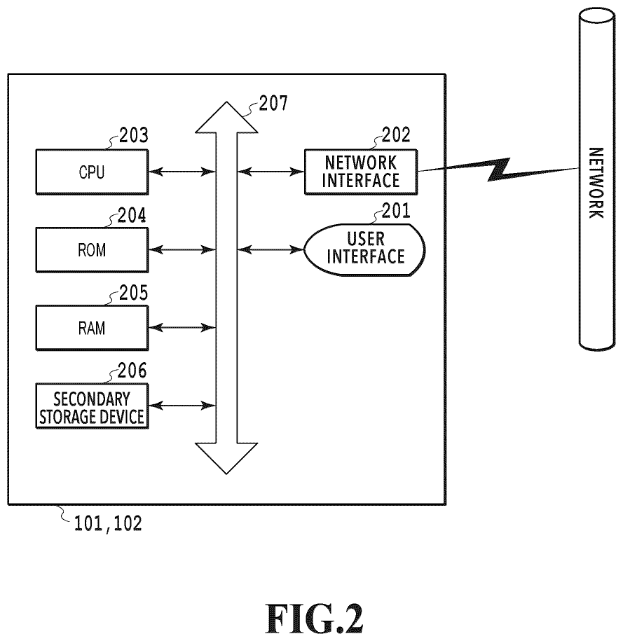

FIG. 2 is a diagram showing one example of the hardware configuration common to the server 101 and the client 102, which are each an information processing apparatus. A user interface 201 is an operation display unit configured to input and output information and signals, including a display, keyboard, mouse, button, touch panel and the like. A network interface 202 connects to a network, such as LAN, and performs communication with another computer and network equipment. The communication method may be either a wired method or a wireless method. A CPU 203 is a central processing unit configured to execute programs read from a ROM 204, a RAM 205, a secondary storage device 206 and the like. The ROM 204 is a nonvolatile memory in which incorporated programs and data are stored. The RAM 205 is a volatile memory providing a temporary memory area. The secondary storage device 206 is a large-capacity storage device, typically such as an HDD and a flash memory. It is also possible to connect to and operate a computer not equipped with the hardware such as this from another computer via a remote desktop, remote shell or the like. Each unit is connected via an input/output interface 207.

### Software Configuration

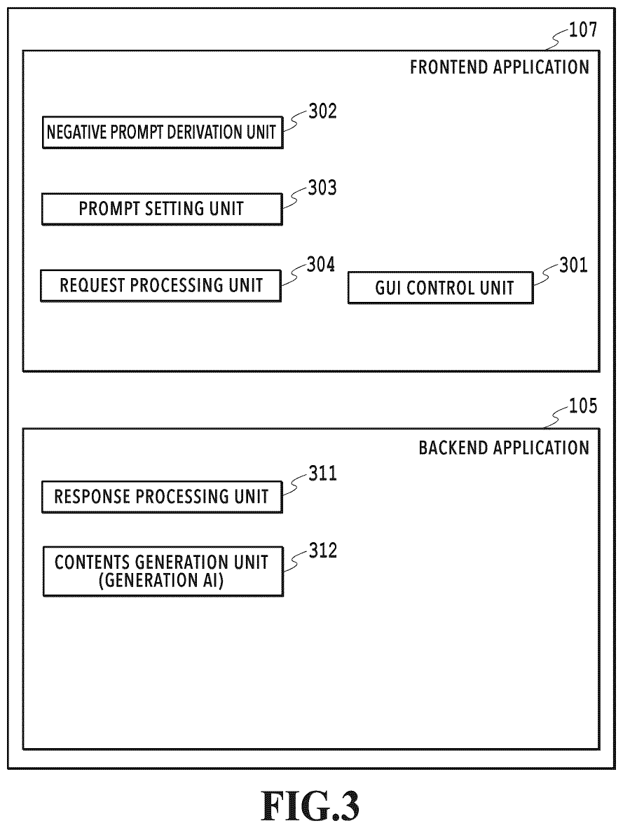

FIG. 3 is a function block diagram showing one example of the software configuration of the frontend application 107 and the backend application 105 respectively. The frontend application 107 has a GUI control unit 301, a negative prompt derivation unit 302, a prompt setting unit 303, and a request processing unit 304. The backend application 105 has a response processing unit 311 and a contents generation unit 312. A configuration may also be acceptable in which one of the frontend application 107 and the backend application 105 includes each of the above-described units 301 to 304 and 311 and 312.

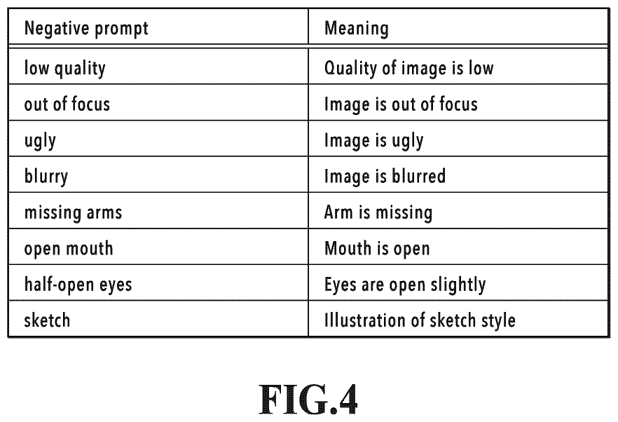

The GUI control unit 301 performs control of a GUI (Graphical User Interface) for presenting information to a user or for a user to input instructions, specifically, performs control of the display of a UI screen, the reception of a user input and the like. As a specific example of user input, there are selection of a template, instructions of a contents insertion method, reception of a character string as a prompt (instruction information including word and sentence) that is input to the generation AI, and the like. The prompts include positive prompts and negative prompts. The positive prompt is a prompt that designates a desirable (element desired to be generated) that is contents the generation AI should generate. For example, in a case where “reindeer” is input as a positive prompt to an AI (image generation AI) generating an image as contents, the image generation AI generates an image of reindeer. In contrast to this, the negative prompt is a prompt that designates an undesirable (element desired to be excluded) that is contents the generation AI should not generate. FIG. 4 is a table summarizing examples of general negative prompts that are input to the image generation AI. For example, in a case where “low quality” is input as a negative prompt to the image generation AI, the image generation AI no longer generates an image of low quality.

The negative prompt derivation unit 302 derives a character string to be used as the above-described negative prompt among the prompts that are input to the generation AI based on obtained information relating to a user. The derivation method will be described later.

The prompt setting unit 303 sets the character string a user inputs via the GUI and the character string the negative prompt derivation unit 302 derives as the positive prompt and the negative prompt, respectively.

The request processing unit 304 performs processing to request the server 101 to generate contents. In requesting, the positive prompt and the negative prompt set by the prompt setting unit 303 are also sent together. Further, the request processing unit 304 also performs processing to receive contents generated by the server 101 in response to the request.

The response processing unit 311 performs response processing to receive a request from the client 102, transmit contents generated in response to the received request to the client 102 from which the request has been made, and so on.

The contents generation unit 312 is a generation AI that generates contents, such as images and text, by taking a positive prompt and a negative prompt as an input. As the image generation AI that generates images as contents, for example, “Stable Diffusion”, “Midjourney” and the like are known. The generation AI is a learned model (contents generation model) obtained by performing machine learning by a method, such as deep learning, for a variety of pieces of data so that target contents are obtained.

Following the above, by taking poster creation software as the frontend application 107 as an example, the flow of the operation of each of the client 102 and the server 101 is explained. The poster creation software is one example that is installed in the client 102 and the software is not limited to this. For example, the present disclosure may be applied to software for obtaining various products, such as photo album creation software and postcard creation software.

### Operation on the Client Side

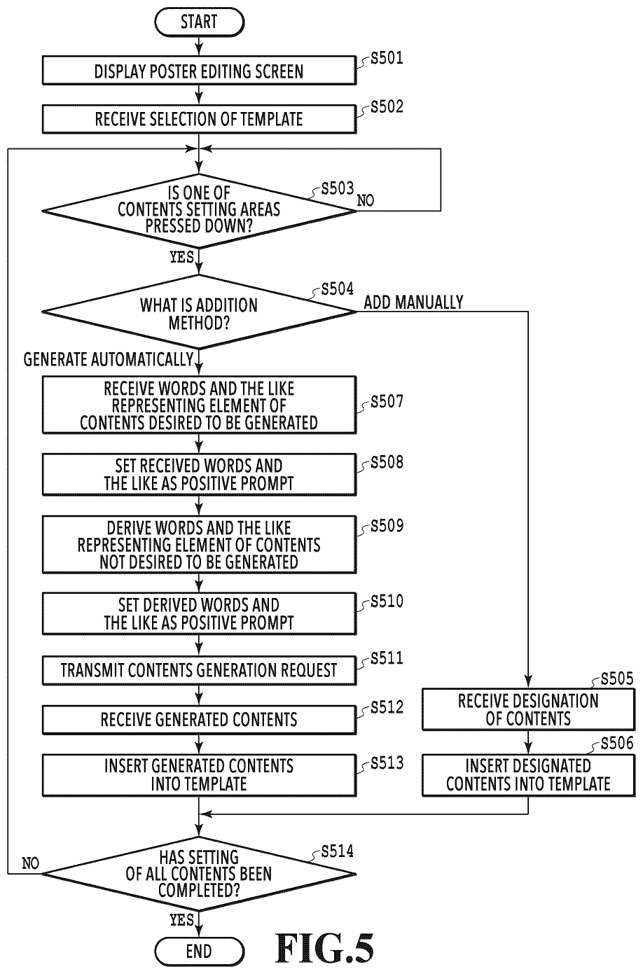

FIG. 5 is a flowchart showing the flow of the operation in the client 102 according to the present embodiment. This flowchart is started by the poster creation software being activated based on user instructions. In the following, a symbol “S” means a step.

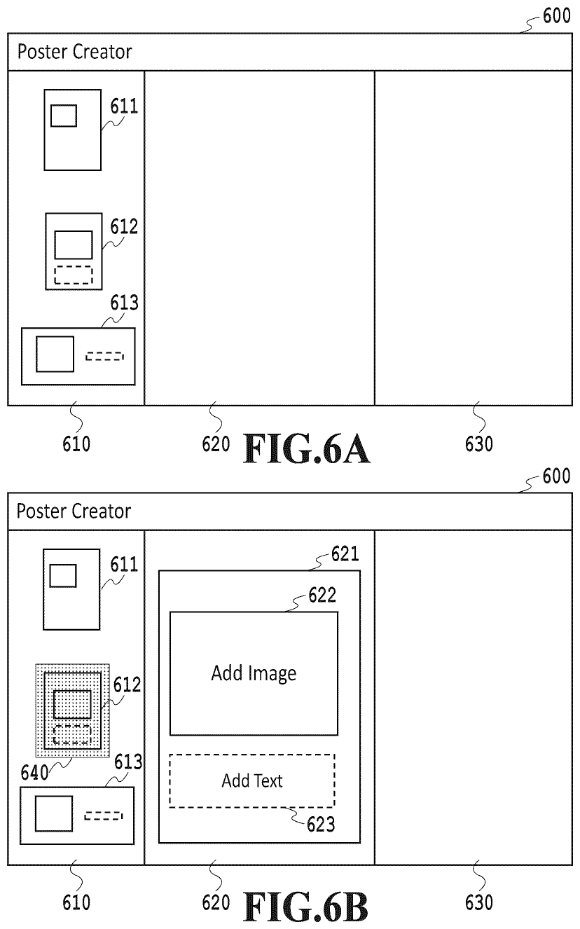

At S501, the GUI control unit 301 displays an editing UI screen (in the following, described as “poster editing screen”) in accordance with the poster creation software on a display of the user interface 201. FIG. 6A shows one example of a poster editing screen. A Poster Creator screen 600 in FIG. 6A includes a template list pane 610, a template editing pane 620, and a contents editing pane 630. The GUI control unit 301 displays a list of a variety of templates in accordance with the purpose and use in the template list pane 610. In the example in FIG. 6A, in the template list pane 610, three templates (611, 612, 613) prepared in advance are displayed.

At S502, the GUI control unit 301 receives a user selection for a specific template among the templates displayed in a list in the template list pane 610. FIG. 6B shows a change of the screen in a case where a user selects the template 612 and a highlight frame 640 indicating the selected state is added. Further, the template 612 selected by a user is displayed as an editing-target template 621 in the template editing pane 620. Here, in the editing-target template 621, an image setting area 622 for a user to set an arbitrary image and a text setting area 623 for a user to set arbitrary text are arranged. In the following, the image setting area and the text setting area are called together “contents setting area”.

At S503, the GUI control unit 301 determines the presence/absence of the pressing down for one of the contents setting areas in the editing-target template displayed in the template editing pane 620. In a case where the pressing down for the contents setting area is detected, the GUI control unit 301 performs S504 following this and in a case where the pressing down is not detected, the GUI control unit 301 determines the presence/absence of pressing down after waiting for a predetermined time to elapse.

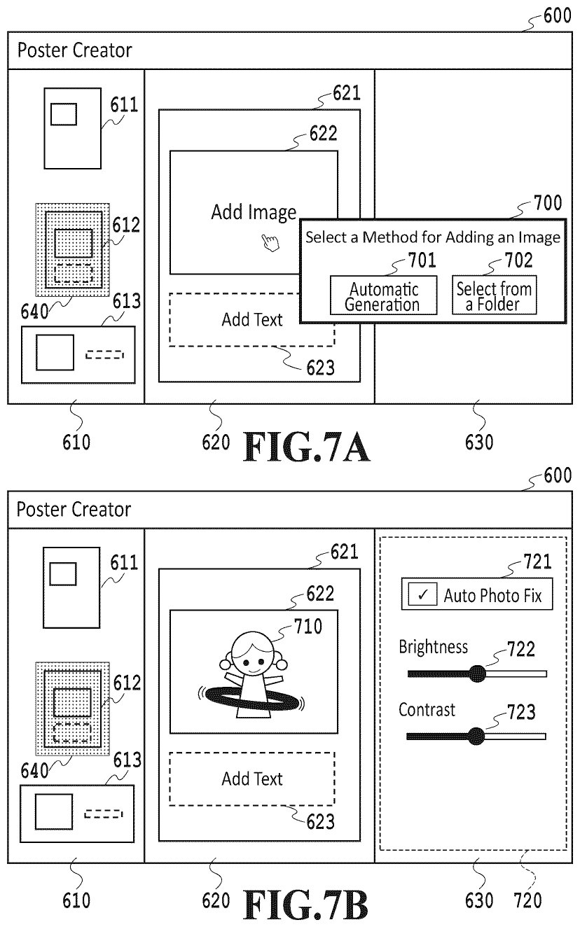

At S504, the GUI control unit 301 displays a popup screen for causing a user to select a method of adding contents in accordance with the contents setting areas pressed down and receives a user selection of whether to manually add target contents or generate automatically. FIG. 7A shows one example in a case where a user presses down the image setting area 622 by operating a pointer in the state in FIG. 6B and a popup screen for selecting whether to automatically generate an image that is added or add manually is displayed. Here, as alternatives of the image addition method, each button of “Automatic Generation” and “Select from a Folder” is displayed. Here, the “Automatic Generation” button is a button in a case where a generation AI is caused to generate an image and the “Select from a Folder” is a button in a case where a user him/herself designates an image from an arbitrary folder and uploads the image. In a case where the text setting area 623 is pressed down at S503, as alternatives of the text addition method, each button of “Automatic Generation” and “Manual Input” is displayed. The “Automatic Generation” button in this case is a button that causes the generation AI to generate text and the “Manual Input” button is a button in a case where a user inputs an arbitrary character string manually. In a case where the pressing down of the button for manual addition is detected, the GUI control unit 301 performs S505 following this and in a case where the pressing down of the button for automatic generation is detected, the GUI control unit 301 performs S507 following this.

At S505, the GUI control unit 301 receives the designation of contents by a user. For example, in a case where the pressing down of the “Select from a Folder” button for manually adding an image is detected at S504, the GUI control unit 301 receives the designation of desired image data from an arbitrary folder. It is possible for a user to designate a desired image from among images stored in advance in the folder by a user him/herself performing image capturing or obtaining via the Internet 104 and the like by the operation, such as drag & drop. Further, in a case where the pressing down of the “Manual Input” button for manually adding text is detected at S504, the GUI control unit 301 receives the designation of a character string via an input field (not shown schematically) for a user to input a desired character string directly by displaying the input field.

At S506, the GUI control unit 301 inserts the contents designated by a user, which are received at S505, into the contents setting area in the template being selected, which is pressed down at S503. FIG. 7B is a diagram showing one example of the state where an image 710 designated by a user is inserted into the image setting area 622. In a case where contents are inserted, in the contents editing pane 630, an operation field 720 for a user to perform the editing operation for the inserted contents is displayed. Here, in FIG. 7B, it is possible to perform editing for the inserted image 710. In this example, a field 721 for a user to instruct whether to correct the editing-target image automatically, a control bar 722 for adjusting the brightness of the image, and a control bar 723 for adjusting the contrast of the image are provided. In a case where the editing-target contents are text, an operation field (not shown schematically) with which the font, size, color and the like of a character can be adjusted is displayed. It is possible for a user to modify the contents and so on by performing a necessary operation appropriately in the operation field in accordance with the editing-target contents.

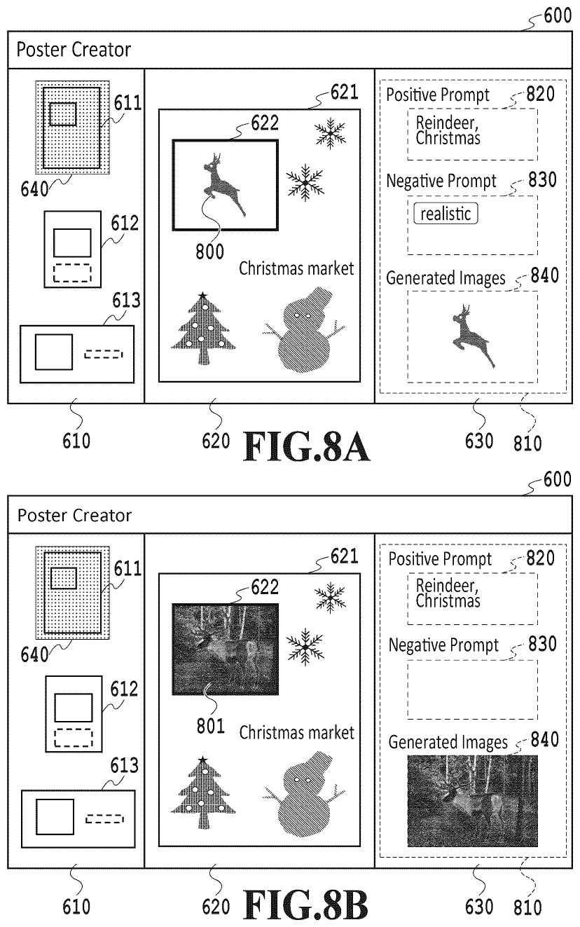

The processing at S507 to S513 is processing for causing the generation AI to generate contents automatically for the contents setting area pressed down by a user and inserting the contents. FIG. 8A and FIG. 8B are each one example of a UI screen in a case where a user selects the template 611 for a Christmas poster in the state in FIG. 6A and then presses down the image setting area 622 of the editing-target template 621 and selects the image automatic generation. In the following, with reference to the UI screen examples as appropriate, the flow until a template is completed by causing the generation AI to generate contents automatically is explained.

First, at S507, the GUI control unit 301 receives an input of a character string of words and the like representing an element of the contents that a user desires to be generated by the generation AI. As the language that is used in a prompt, generally English is used frequently, and therefore, description is in English in the present embodiment, but it is needless to say that language is not limited to English because the language that is used in a prompt depends on the generation AI. Here, it is assumed that the words “Reindeer” and “Christmas” are input via an input field, not shown schematically.

At S508, the prompt setting unit 303 sets the character string of words and the like a user has input at S507 as a positive prompt. Here, the two words “Reindeer” and “Christmas” have been input by a user, and therefore, these words are set as a positive prompt.

At S509, the negative prompt derivation unit 302 derives the character string of words and the like representing the element of the contents a user does not desire to be generated by the generation AI based on the template selected by a user. As the derivation method based on the template, a method is considered which refers to metadata of the template relating to the user selection by appending in advance a character string for the negative prompt in accordance with its feature as the metadata for each template that is displayed in the template list. Alternatively, it may also be possible to prepare a table in advance in which each template and a character string for a negative prompt are associated with each other and refer to the table. Further, it may also be possible to derive the character string by using a trained model that estimates a character string not suitable to the impression of the template selected by a user. It is possible to obtain the trained model that is used for this estimation by learning a large amount of training data in which a template and words and the like not suitable to the impression of the template are paired. In a case of estimation, it may also be possible to estimate the impression of the entire target plate or estimate the comprehensive impression of the entire template after estimating the impression of each contents, such as an image and text included in the target template. In the example in FIG. 8A, the template of illustration style on the theme of Christmas is selected. In this case, even though an image of reindeer living in the natural world, such as a captured photo of reindeer, is generated, this is not suitable to the template of illustration style on the whole. Because of this, for the template of illustration style, a word, such as “realistic”, is associated in advance by the above-described method. Due to this, by just the selection of a desired template by a user, a negative prompt suitable to the template is also obtained and set automatically, and therefore, it is possible for a user to save time and effort to find and set a negative prompt by him/herself. In a case where a template of illustration style is selected, it is also possible for a user him/herself to set a character string, such as “Illustration style”, as a positive prompt and cause the generation AI to generate an image of illustration style. However, with the method of the present embodiment, it is not necessary for a user to find and set such a positive prompt each time, and therefore, it is possible to save more time and effort.

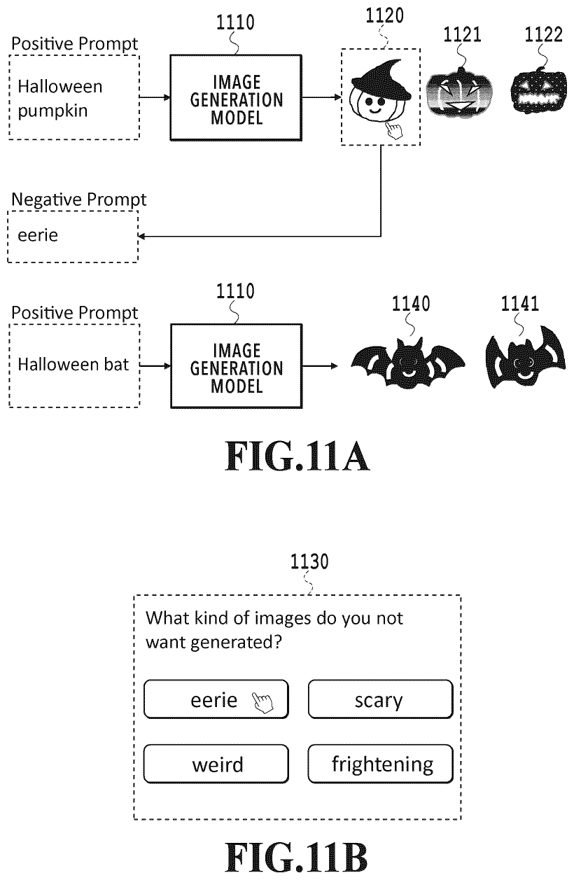

At S510, the prompt setting unit 303 sets the character string of words and the like derived at S509 as a negative prompt. In the example described above, the word “realistic” is set automatically as a negative prompt. As shown in FIG. 11B, to be described later, it may also be possible to enable a user to set a word that is set as a negative prompt from among a word group derived at S509 via a GUI.

At S511, the request processing unit 304 transmits a contents generation request to the server 101 that provides contents generation services. In this contents generation request, information on the positive prompt set at S508 and the negative prompt set at S510 is included. Upon receipt of the contents generation request, in the server 101, the automatic generation of contents based on the positive prompt and the negative prompt is performed. Details of the automatic generation of contents in the server 101 will be described later.

At S512, the request processing unit 304 receives the contents generated based on the contents generation request from the server 101.

At S513, the GUI control unit 301 inserts the contents received at S512 into the contents setting area pressed down at S503 in the template being selected. In the example in FIG. 8A, an image of reindeer 800 of illustration style is inserted into the image setting area 622 and in the contents editing pane 630, an operation field 810 for a user to perform the editing operation for the image 800 is displayed. In the operation field 810, two subfields 820 and 830 indicating the positive prompt and the negative prompt used for the generation of the inserted image 800 are provided and further, a subfield 840 displaying only a generated image is provided. FIG. 8B is a diagram showing a specific example in a case where “realistic” is not set as the negative prompt and a real image of reindeer 801 like a captured photo of the natural world is generated by the generation AI. It may also be possible to enable a user to perform fine adjustment of hue and the like by using the control bar described previously by taking the image displayed in the subfield 840 as a target.

At S514, whether or not all the contents to be set have been set is determined for the template selected at S502. In a case where there are contents not set yet, the processing returns to S503 and the processing is continued. On the other hand, in a case where all the contents have been set, this processing is terminated.

The above is the explanation of the operation on the client side. In the flow in FIG. 5 described above, it may also be possible to provide a step at which a user checks on the UI screen whether to apply the negative prompt automatically set at S510 as it is before the contents generation request is transmitted. Further, it may also be possible to cause the generation AI to generate an image anew by a user him/herself adding, changing, and so on the character string in the subfields 820 and 830.

The above-described method can be applied to a variety of cases. For example, in a case where there is an unwritten rule for certain traditional food (for example, a specific food material X must not be used), it is sufficient to associate a character string, such as “X as an ingredient that should not be used”, with the template of the traditional food. Due to this, even for a user who does not know a rule relating to the traditional food, a character string representing the food material X is set automatically as the negative prompt in a case where the user selects the template for the traditional food. Because of this, it is possible to prevent the generation AI from erroneously generating contents including the food material X.

### Operation on the Server Side

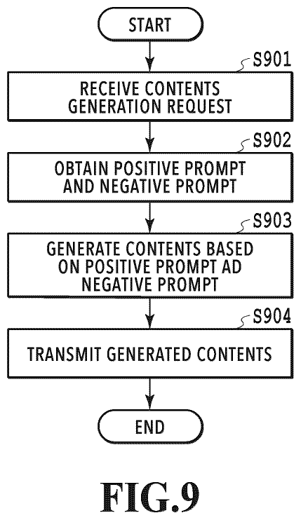

FIG. 9 is a flowchart showing a flow of the operation of the backend application 105 of the server 101 in a case of generating contents in response to the contents generation request (S511) from the client 102. In the following explanation, a symbol “S” means a step.

At S901, the response processing unit 311 receives the contents generation request from the client 102. At S902, the contents generation unit 312 obtains the positive prompt and the negative prompt from the contents generation request received at S901. At S903, the contents generation unit 312 generates contents by taking the positive prompt and the negative prompt obtained at S902 as an input. At S904, the response processing unit 311 transmits the data of the contents generated at S903 to the client 102 having made the request.

The above is the explanation of the operation on the server side. In the present embodiment, the configuration is such that the generation AI is included in the backend application 105, but the configuration is not limited to this. For example, a configuration is also acceptable in which the generation AI is located outside the backend application 105 and the backend application 105 responds to the contents generation request by calling the external generation AI.

### Variation of Character String Derivation Method

In the example described above, the character string that is used as a negative prompt is derived by associating a specific character string in advance with each template, but the method of deriving a character string of a negative prompt is not limited to this. In the following, a variation of the method of deriving a character string for a negative prompt is explained.

### Derivation Based on User Attribute

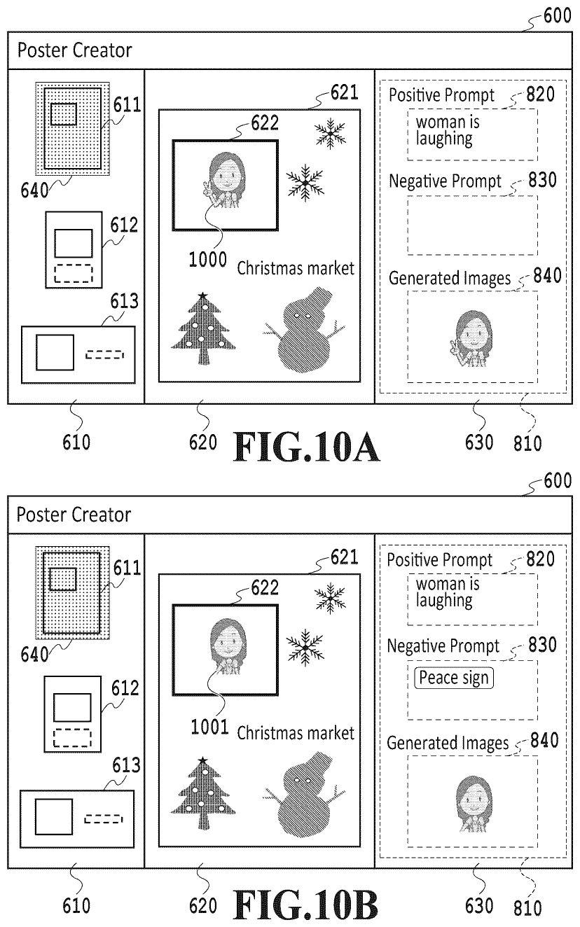

Generally, in a case of software that implements the function, such as poster creation, by cloud services, in many cases, a user utilizes the software by registering an account in advance and logging in. In a case of registering an account, a user also registers attribute information together, such as his/her name, sex, nationality, region, language, and hobby. In a case of software whose service is developed in many countries in the world, the software is utilized by users of a variety of nationalities, but the culture and custom are different for different nationalities and for example, the same gesture is regarded differently depending on the country. For example, in a case of the peace sign, which is one kind of body language, while there is a country in which this gives a good impression, there is a country in which this gives a bad impression. Consequently, in a case where the nationality indicated by the attribute information on a login user indicates a country in which the peace sign gives a bad impression, the derivation method is designed so that “Peace sign” is derived as a character string of a negative prompt. As a specific derivation method, it is sufficient to register in advance a character string indicating a gesture or the like for each country in a database, which is considered taboo, then make an enquiry about the nationality of a user in a case where the user logs in and obtain a character string registered in association with the country of the user. FIG. 10A and FIG. 10B are each one example of a UI screen in a case where a user selects the template 611 on the UI screen in FIG. 6A described previously, presses down the image setting area 622 of the editing-target template 621, and selects image automatic generation. FIG. 10A is an example in a case where the nationality of the login user is the country in which the peace sign does not give a bad impression and FIG. 10B is an example in a case where the nationality of the login user is the country in which the peace sign gives a bad impression. In each case, the character string of “woman is laughing” is set as a positive prompt, but in FIG. 10B, “Peace sign” is further set as a negative prompt. As a result of that, in the example in FIG. 10A, the generation AI generates an image 1000 of a woman who is smiling with the peace sign, but in the example in FIG. 10B, the generation AI generates an image 1001 of a woman who is smiling without the peace sign. By setting a negative prompt in accordance with the nationality of a user as described above, it is possible to prevent contents not suitable to the user from being generated. Here, the nationality is used as the attribute information on a user, but it may also be possible to user another user attribute, for example, such as a region including a plurality of countries or used language. In this case, it is sufficient to register in advance a character string representing a gesture or the like in the database, which is considered taboo, for each attribute, such as region and language, and then, derive a character string in according to the attribute of a login user and set a negative prompt. Further, in place of the attribute at the time of account registration, it may also be possible to derive a character string of a negative prompt by estimating the above-described attribute of a user from information after account registration, such as behavior history and IP address of the user, and using the estimated attribute information. Even in a case of a user whose nationality indicates the country in which the peace sign gives a bad impression, on a condition that the user inputs a character string of a representation with an intentional insult as a positive prompt, it may also be possible to give priority to the positive prompt so that “Peace sign” is not set as a negative prompt.

### Derivation Based on User Selection for Contents

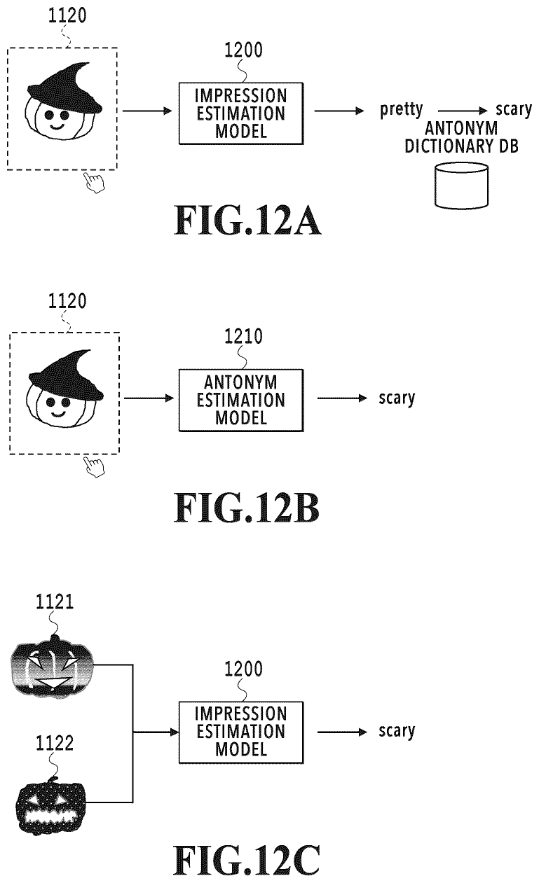

Following the above, a method of deriving a character string of a negative prompt based on user selection for contents within a template is explained. Specifically, the impression of an image a user has selected from among images generated by the generation AI is estimated by using a leaned model (impression estimation model) for impression estimation and a character string corresponding to an antonym of the character string representing the estimated impression is obtained from a dictionary database. FIG. 11A is a diagram explaining the way a negative prompt is set based on the image selected by a user from among a plurality of images generated by an image generation model, which is the generation AI. Here, as the positive prompt, “Halloween pumpkin” is set. Then, by taking this as an input, an image generation model 1110 generates three images 1120, 1121, and 1122 of a pumpkin deformed into the Halloween style. These thee images include the image 1120 with an impression of “pretty” and the images 1121 and 1122 with an impression of “scary” as well. Here, it is assumed that a user selects the image 1120 with an impression of “pretty” as an image the user desires to be inserted into the template. In this situation, in a case where the user inputs the selected image 1120 to the impression estimation model, an impression of “pretty” is estimated. Next, the user inputs the word “pretty” representing the estimate impression into the dictionary database. As a result of that, the words “scary”, “eerie”, “weird”, and “frightening” representing an impression opposite to or deviating from “pretty” are obtained. FIG. 12A is a diagram showing the way the impression “scary” opposite to “pretty” is derived by further inputting the impression “pretty” obtained by inputting the image 1120 selected by the user to an impression estimation model 1200 to the dictionary database. FIG. 11B is one example of a UI screen on which for a user to select and set a negative prompt from the word group thus derived. The GUI control unit 301 of the frontend application 107 displays a candidate dialog 1130 including the derived word group. The user selects a word representing an impression that the user does not want generated from among the word group displayed in the candidate dialog. In this example, “eerie” is selected and in Negative Prompt, “eerie” is set. Then, in a case where the user sets “Halloween bat” in Positive Prompt and inputs it to the image generation model 1110, images 1140 and 1141 of bat whose impression is “pretty” are generated. It may also be possible to derive a character string in Negative Prompt from the image selected by a user by using the impression estimation model and the dictionary database as described above. Here, a user selects one word from among the derived word group, but it may also be possible to set the derived one or plurality of derived words in Negative Prompt as they are.

Further, it may also be possible to add the word “pretty” representing the impression estimated from the image selected by a user to Positive Prompt. Furthermore, it may also be possible to derive a character string in Negative Prompt from the image selected by a user more directly by using the learned model (antonym estimation model) 1210 capable of estimating the antonym of the word representing the impression of the image as shown in FIG. 12B. It is possible to obtain the antonym estimation model in this case by learning a large amount of training data in which an image and a word not suitable to the impression of the image are paired. The image that is used as training data that is used for learning may be one generated by the generation AI or one captured by a person with a camera.

In the example described above, the character string in Negative Prompt is derived based on the image 1120 selected by a user, but it may also be possible to derive the character string based on the images 1121 and 1122 not selected by a user. Here, the images 1121 and 1122 not selected by a user are both images whose impression is “scary”. Consequently, by inputting these images to the impression estimation model 1200, it is possible to estimate “scary” representing the impression common to both images. The number of images that are input to the impression estimation model may be three or more or one.

Further, the example is explained in which the character string is derived based on the image not selected by a user among the images generated by the generation AI, but the example is not limited to this. For example, it may also be possible to derive the character string based on the image not selected by a user among the images for insertion into the template, which are prepared in advance by a poster creation software.

Further, it may also be possible to update the generation AI by performing additional learning in association with a user by using a method, for example, such as LoRA (Low-Rank Adaptation), by taking the image not selected by the user as a bad example. Due to this, in a case where each user utilizes the generation AI next time and subsequent times, the image not suitable to the preferences of a login user is hard to be generated by using the generation AI updated for each user.

As the impression estimation model or the antonym estimation model, for example, the learned model having learned by the method of deep learning is supposed, like the contents generation model, but the model is not limited to this.

### Modification Example

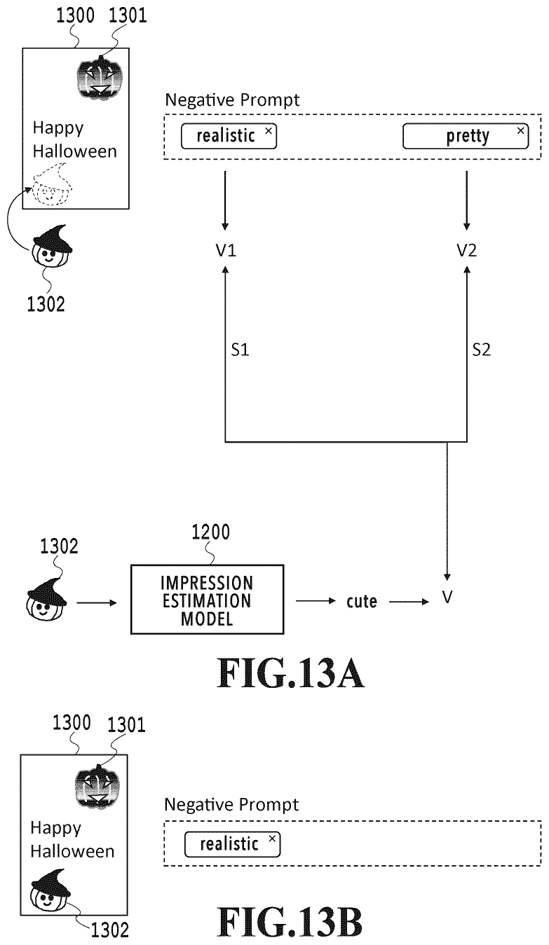

It may also be possible to automatically update the negative prompt automatically set in a process in which a user edits the template. FIG. 13A and FIG. 3B are diagrams explaining automatic updating of a negative prompt. Here, it is assumed that “realistic” and “pretty” are associated as a negative prompt in advance with a template 1300. Then, a user gives instructions to add an image by automatic generation by using “Halloween pumpkin” in Positive Prompt. As a result of that, an image 1301 of pumpkin in the illustration style and whose impression is “scary” is generated by the generation AI and arranged at the upper-right position of the template 1300. In FIG. 13A, V1 and V2 are “realistic” and “pretty” converted respectively into a vector presentation by using a method, such as Word2Vec. The method of converting a word into a vector representation is not limited to the method of Word2Vec and another method may be used. Next, it is assumed that a user inserts an image 1302 of pumpkin to the lower-bottom position of the template 1300 by drag & drop or the like. Then, this image 1302 of pumpkin is input to the impression estimation model 1200 described previously and the impression “cute (pretty/young)” is estimated. In FIG. 13A, V is the estimated impression “cute” converted into a vector representation. In this case, on a condition that a cosine similarity S1 between V and V1 and a cosine similarity S2 between V and V2 are found and both are compared, the value of S2 will be larger. The reason is that the meaning of “pretty” is closer to that of “cute” than that of “realistic”. In a case where the degree of similarity between the impression and the impression of the image added by a user him/herself is high, the impression is not appropriate as a negative prompt, and therefore, “pretty” is deleted from Negative Prompt as shown in FIG. 13B. Due to this, the negative prompt for the template 1300 is updated to only “realistic”. As described above, it may also be possible to automatically update a negative prompt in a process in which a user edits the template. Due to this, for example, in a case where a user designates “Halloween bat” in Positive Prompt and gives instructions to automatically generate an image, the image of bat whose impression is “pretty” is also generated. By automatically updating a negative prompt in accordance with the editing operation of a user as described above, it is possible to cause the generation AI to generate contents suitable to the impression changed by editing.

Further, in the embodiment described above, it is possible for a user to check an automatically set negative prompt on a UI screen, but it may also be possible to apply an automatically set negative prompt in a form that a user cannot see without displaying it on a UI screen.

Further, it may also be possible to enable a user to change the representation of a negative prompt automatically derived and set by the above-described embodiment into, for example, such as changing “cute” into “pretty”.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to easily set an appropriate prompt for obtaining desired contents.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-002654, filed Jan. 11, 2024 which is hereby incorporated by reference wherein in its entirety.

What is claimed is:

1. An information processing apparatus for causing a generation AI to generate contents, the information processing apparatus comprising:
one or more memories storing instructions; and
one or more processors executing the instructions for:
deriving a specific character string based on information obtained relating to a user; and
setting the derived specific character string as a negative prompt designating the generation AI should not to generate what kind of contents.

2. The information processing apparatus according to claim 1, wherein
in the information processing apparatus, software for obtaining a product in which contents generated by the generation AI are incorporated is installed and
in the deriving, based on selection of a user for a template prepared for the product, a specific character string associated in advance with the selected template is derived.

3. The information processing apparatus according to claim 2, wherein
to a plurality of the templates, a specific character string in accordance with each feature is appended as metadata and
in the deriving, with reference to metadata of the template selected by a user, a specific character string associated with the template is derived.

4. The information processing apparatus according to claim 2, wherein
in the deriving, with reference to a table in which each of the plurality of templates and a character string for negative prompt area associated with each other, a specific character string associated with the template selected by a user is derived.

5. The information processing apparatus according to claim 1, wherein
in the deriving, by using a learned model estimating a character string not suitable to an impression of an input template, a character string not suitable to an impression of the template selected by a user is derived as the specific character string.

6. The information processing apparatus according to claim 2, wherein
the one or more processors further execute the instructions for:
controlling a GUI for a user; and
in the controlling, automatically updating a set negative prompt based on an editing operation by a user on the GUI for the template selected by a user.

7. The information processing apparatus according to claim 6, wherein
the automatic updating is processing to delete the negative prompt in a case where an impression of the specific character string set as the negative prompt and an impression of contents a user him/herself has added to the template selected by a user are similar to each other.

8. The information processing apparatus according to claim 1, wherein
in the deriving, the specific character string is derived based on attribute information indicating an attribute of a user.

9. The information processing apparatus according to claim 8, wherein
in the deriving, a specific character string in accordance with an attribute identified by the attribute information is derived by using a database in which the specific character string is registered for each attribute.

10. The information processing apparatus according to claim 9, wherein
an attribute identified by the attribute information is one of sex, age, hobby, nationality, region including a country of the nationality of a user, and language a user uses.

11. The information processing apparatus according to claim 10, wherein
in the deriving, the attribute is estimated by using information on behavior history of a user or IP address of a user and a specific character string in accordance with the estimated attribute is derived.

12. The information processing apparatus according to claim 1, wherein
the information processing apparatus is an information processing apparatus in which software for obtaining a product incorporating contents generated by the generation AI is installed,
the one or more processors further execute the instructions for:
controlling a GUI for a user,
in the controlling, selection of a user for contents within a template prepared for the product is received via the GUI, and
in the deriving, based on selection of a user for contents within a template prepared for the product, a character string corresponding to an antonym of a character string representing an impression of selected contents or a character string representing an impression of contents not selected by a user is derived as the specific character string.

13. The information processing apparatus according to claim 12, wherein
in the deriving, in a case where a character string corresponding to an antonym of a character string representing an impression of contents selected by a user is derived as the specific character string, an impression of contents selected by a user is estimated by using a learned model estimating an impression of input contents and a character string representing an impression opposite to an estimated impression is derived.

14. The information processing apparatus according to claim 13, wherein in the deriving, a character string corresponding to an antonym of a character string representing an estimated impression is derived by using a dictionary database.

15. The information processing apparatus according to claim 12, wherein
in the deriving, in a case where a character string representing an impression of contents not selected by a user is derived as the specific character string, an impression of contents not selected by a user is estimated by using a learned model estimating an impression of input contents and a character string representing an estimated impression is derived.

16. The information processing apparatus according to claim 12, wherein the generation AI is updated by performing additional learning taking contents not selected by a user as a bad example.

17. The information processing apparatus according to claim 1, wherein
the one or more processors further execute the instructions for:
controlling a GUI for a user and
in the controlling, the set negative prompt is displayed on the GUI and selection of a user for the set negative prompt is received.

18. The information processing apparatus according to claim 1, wherein
the one or more processors further execute the instructions for:
generating contents by inputting a positive prompt designating the generation AI to generate what kind of contents and the set negative prompt to the generation AI.

19. The information processing apparatus according to claim 1, wherein
the one or more processors further execute the instructions for:
requesting an external information processing apparatus having the generation AI to generate contents as well as a positive prompt designating the generation AI to generate what kind of contents and the set negative prompt; and
receiving contents generated based on the request.

20. The information processing apparatus according to claim 1, wherein the contents are an image.

21. The information processing apparatus according to claim 1, wherein the contents are text.

22. An information processing method for causing a generation AI to generate contents, the information processing method comprising:
deriving a specific character string based on information obtained relating to a user; and
setting the derived specific character string as a negative prompt designating the generation AI should not to generate what kind of contents.

23. A non-transitory computer readable storage medium storing a program for causing a computer to perform an information processing method for causing a generation AI to generate contents, the information processing method comprising:
deriving a specific character string based on information obtained relating to a user; and
setting the derived specific character string as a negative prompt designating the generation AI should not to generate what kind of contents.
